(19) United States
(12) Patent Application Publication
(10) Pub. No.: US 2012/0167867 A1
(43) Pub. Date: Jul. 5, 2012

(54) Beverage can shaped grill

(76) Inventors: Mark S. Fisher, Northridge, CA (US); Debra Canfield, Dallas, TX (US)

(21) Appl. No.: 12/930,182

(22) Filed: Dec. 29, 2010

(51) Int. Cl. A47J 37/07

(52) U.S. Cl. 126/25 R; 126/39 B

(57) ABSTRACT

A beverage can shaped grill with a hollow cylindrical member that is proportional and similar in shape to the sides of a standard twelve ounce metal beverage can and a fixedly attached plate forming a bottom portion for the cylindrical shape. A hinged top member forms a first grill cover that is proportional and similar in shape to the top of a standard twelve ounce beverage can. The first grill cover can be rotated opened to form a table top. A second grill cover is stored within the cylinder shape and is used during grilling. The interior of the cylindrical shape houses a standard gas grill and standard gas tank as well as standard flame controlling knobs. The outside of the cylinder is printed with a graphic image that is found on outer surface of a particular brand of beverage.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of portable grilling devices and more specifically to a beverage can shaped grill.

Gas grill devices are well known. Outdoor grilling at home or at a tail gate party usually takes place on a portable grill. Portable grills usually include a tank of gas such as propane which is hooked to a flame producing plenum located at the bottom of a grilling enclosure. A food to be grilled is placed on a cooking surface located above the flame producing aperture. A grill cover usually is available to be placed on top of the grill enclosure during the cooking process to retain heat generated by the grilling flame.

Portable as grills have been designed and produced in many shapes and sizes. However, to date, no gas grill has been designed to appear to look like a beverage can when the grill is in the closed position.

Additionally, no beverage can shaped grill has included a top portion that when opened can form a table top.
Finally, no beverage can shaped grill has included a secondary lid that can be stored within the can shape when not in use, and can cover the grill enclosure when grilling is taking place.

### BRIEF SUMMARY OF THE INVENTION

The primary object of the invention is to provide a beverage can shaped grill that has the proportional shape of a standard twelve ounce metal beverage can but conceals a standard grill within.

Another object of the invention is to provide a beverage can shaped grill that includes a top portion that is formed to look like a can top and is hinged and forms a table top when opened.

Another object of the invention is to provide a beverage can shaped grill that includes a hinged table top support member that is flush with the outer surface of the cylindrical can shape.

A further object of the invention is to provide a beverage can shaped grill that includes a hinged carry handle member that is flush with the outer surface of the cylindrical can shape.

Yet another object of the invention is to provide a beverage can shaped grill that includes a secondary grill top cover that can be stored within the body of the can shape.

Still yet another object of the invention is to provide a beverage can shaped grill that includes an access door that is flush with the outer surface of the cylindrical can shape.

Another object of the invention is to provide a plurality of grilling tools that hang on hooks mounted to the inside of the access door.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a beverage can shaped grill comprising: a hollow cylindrical member that is proportional and similar in shape to a standard twelve ounce metal beverage can, a fixedly attached plate forming a bottom portion for said cylindrical shape, a hinged top member forming a first grill cover that is proportional and similar in shape to the top of a standard twelve ounce beverage can, a hinged support member that when folded is flush with the outside surface of said cylindrical shape and when opened can support said hinged top member in a position that is parallel to the ground, a hinged door member that when closed is flush with the outside surface of said cylindrical shape, a standard gas grill burner plenum, a standard gas grill base enclosure having a circular base plate and attached side walls, a standard gas grill flame controlling device, a standard gas grill tank hookup, a standard gas grill cooking surface, a second grill cover, said standard gas grill base residing at the upper region within said hollow cylindrical member and sized to allow free air space between the outer walls of said grill enclosure and the inner walls of said cylindrical member, said standard grill cooking surface and said gas burner residing within said grill base enclosure in a standard way, a plurality of heat resisting support members, said heat resisting support members attached on one side to the outer side wall of said standard grill base enclosure and on the opposite side to the inside wall of said hollow cylindrical member, said hollow cylindrical member capable of removably retaining a standard gas tank, said gas grill hookup residing within said cylindrical member in a standard way, said standard grill flame controlling device positioned within said cylindrical member and available for use when said hinged door member is opened, and said hinged door member large enough to allow a user to remove and replace said standard gas tank, said second grill cover removably residing within said cylindrical member, said second grill cover capable of covering said grill enclosure member during a grilling event.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention. in the closed position.

FIG. 2 is a perspective view of the invention in the open position.

FIG. 3 is a side section view of the invention.

FIG. 4 is a side section view of the invention during the grilling process.

FIG. 5 is a rear view of the invention.

FIG. 6 is a side view of the invention.

FIG. 7 is a side section view of a first alternate embodiment of the invention.

FIG. 8 is is a side section view a second alternate embodiment of the invention.

FIG. 9 is a side view of a beer bottle version of the invention.

FIG. 10 is a side section view of the beer bottle version of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

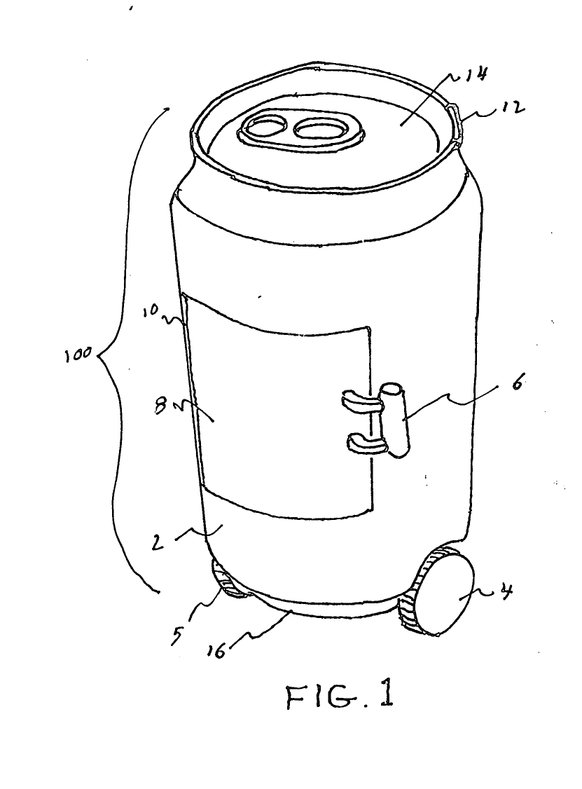

Referring now to FIG. 1 we see a perspective view of the present invention of a beverage can shaped grill 100 in the closed position 100. The overall shape of the grill 100 is proportionately sized to appear like a twelve ounce aluminum or steel beverage can. The top portion 14 includes a depressed area and pull tab ring that are found on a typical beverage can. The side walls of the grill 100 can be imprinted with the logo and graphics of a typical beverage manufacturer such as Miller Beer, or Coca Cola. The grill 100 is oriented in a veridical position similar to a standard beverage container. In the preferred embodiment shown, a pair of wheels 4, 5 are located at the bottom portion 16 of the cylindrical can shape 2.

A door portion 8 is flush with the exterior of the hollow cylindrical portion 2 and is attached by standard hinge 10. A handle 6 is attached to the door 8 allowing the user to open the door and gain access to the interior of cylindrical portion 2. A hinge member 12 attaches the top portion 14 to the cylindrical portion 2.

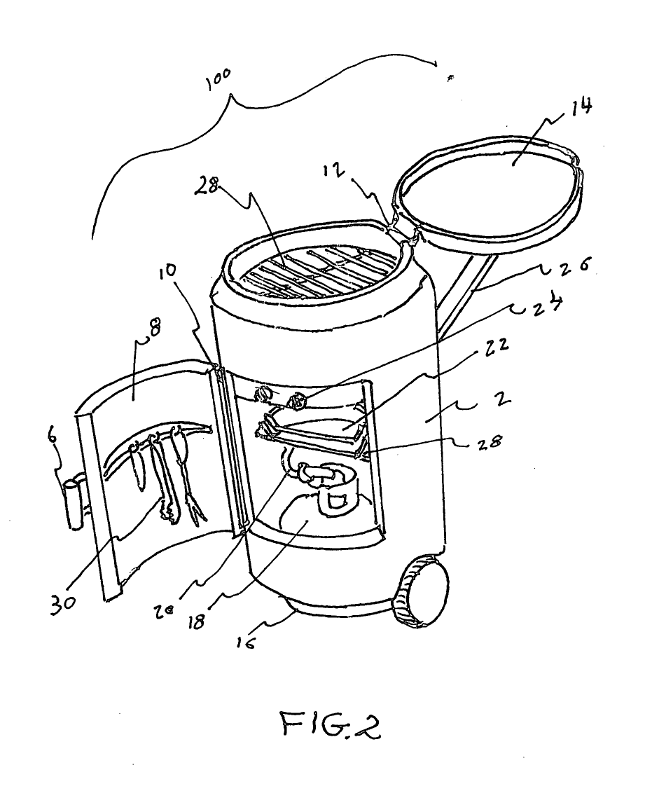

Referring now to FIG. 2 we see a perspective view of the invention 100 in the open, use position. The top portion 14 has been rotated to the open position via hinge member 12. The top portion 14 is held in a horizontal position by support strut 26. Cooking surface 28 is now exposed and ready for use. Door 8 has been opened exposing interior elements including a standard gas tank 18, grill cooking control knobs 24, gas flow control tubes 20 and a shelf 28 that holds secondary grill lid 22. In the preferred embodiment a series of grilling tools 30 are supported by standard hooks attached to the inside surface of door 8.

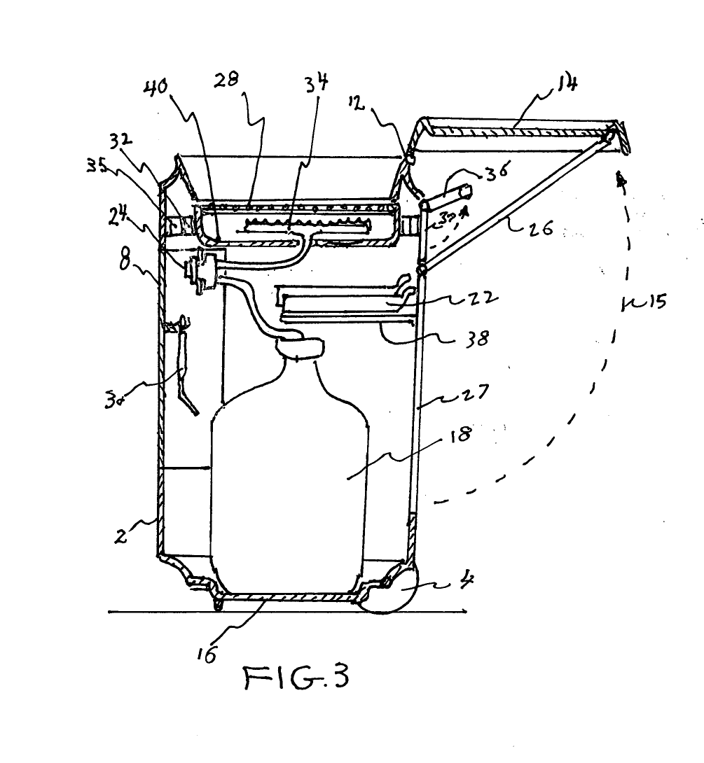

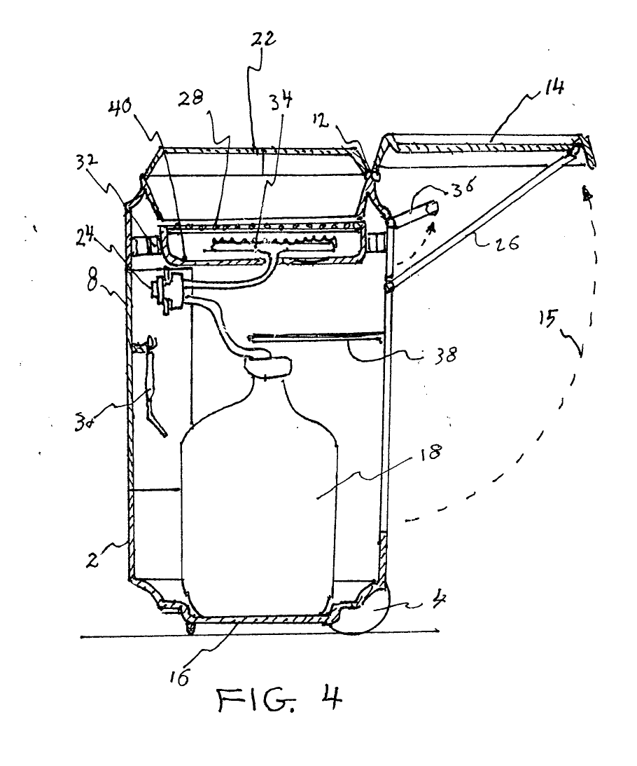

FIG. 3 shows a side section view that bisects the invention 100. In this view the internal components can be clearly seen including standard grill enclosure base 40 and gas burner flame plenum 34. The grill enclosure base 40 is formed by a bottom portion and a cylindrical side wall and is supported by support brackets 35. Each bracket includes a temperature resisting block 32 that prevents the high temperature generated witching the enclosure 40 from migrating to the outer cylindrical wall 2. The free air between the outer enclosure 40 wall and the inner surface of cylindrical housing 2 also act to prevent heat from the grilling enclosure 40 from reaching the outer housing 2. Top support strut 26 is shown in the swung up position as indicated by dotted line 15. A pull handle 36 is also shown in the swung up, use position. The support strut 26 and the handle 36 are both designed to be flush with the outside of the cylindrical wall 2 by fitting into recesses 27 and 37 respectively. Shelf 38 can be seen supporting secondary grill top 22. The grill top 22 is made in two pieces for easy storage, and then assembled into one standard lid 22 as shown in FIG. 4 so that it can form the top to enclosure 40 thereby containing the heat generated by the gas flame emanating from gas burner plenum 34.

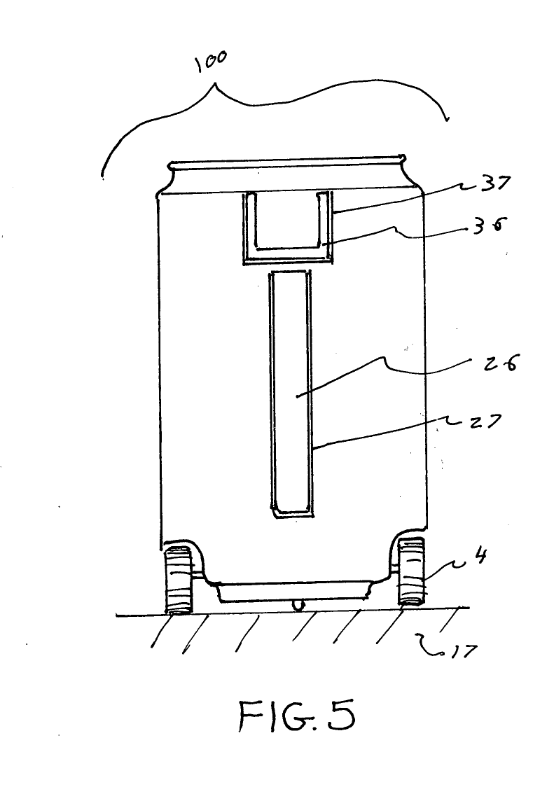

FIG. 5 shows a rear view of the invention 100 sitting on ground plane 17. Support strut 26 can be clearly seen residing in recess 27. Handle portion 36 can also be seen residing in its recess 37.

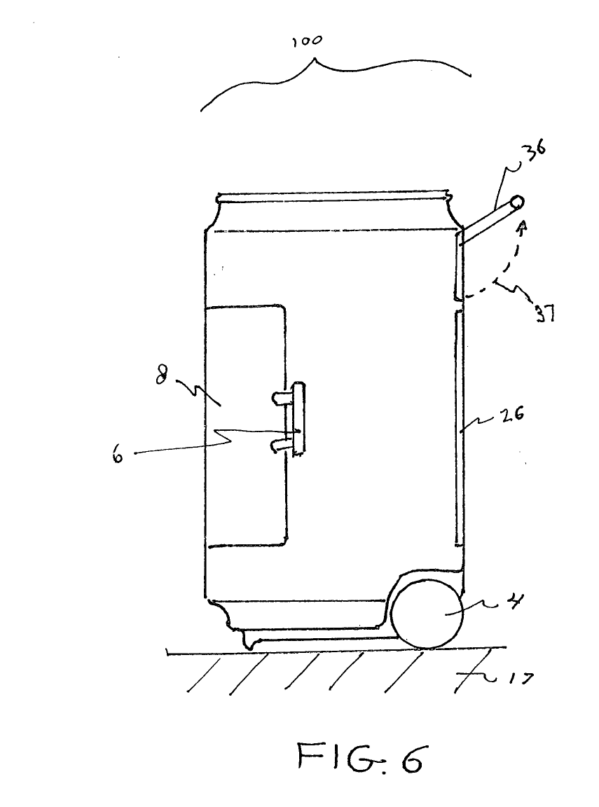

FIG. 6 shows a side view of the invention 100. Door 8 and handle 6 can be clearly seen. Pull handle 36 rotated 37 into the use position so that a person can tilt the can shaped grill 100 back and roll it via wheels 4.

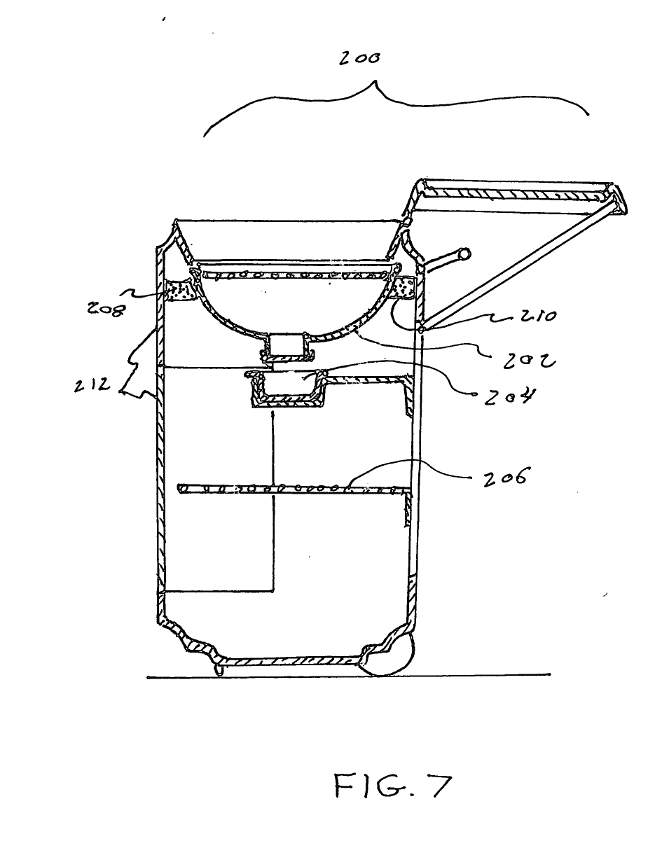

FIG. 7 is a side section view of a first alternate embodiment of the invention 200. In this version, a charcoal type grill 202 replaces the gas type grill found in the original embodiment. Insulating blocks 208, 210 prevent heat from traveling from the grill 202 to the outer housing 212. Open topped container 204 catches ashes from the used charcoal in the standard way. A shelf 206 allows for greater use of free space within the housing bottom area.

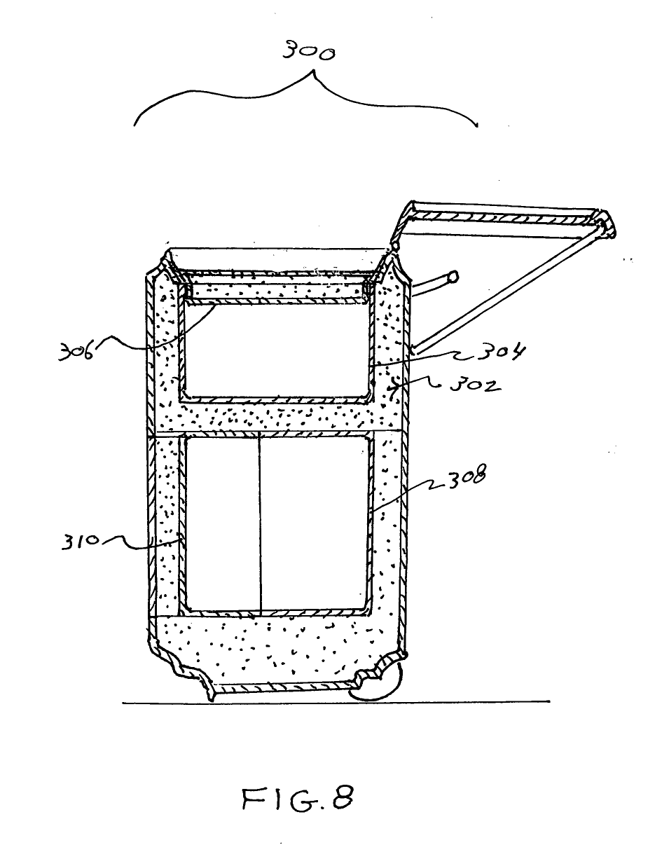

FIG. 8 shows a side section view of a second alternate embodiment of the invention 300. This version is not a grill but retains the can shape of the original embodiment, as well as the hinged table top. The second alternate embodiment is a cooler commonly used for keeping drinks and other food items cold. An upper level insulated container comprised of 304 housing and lid 306 is surrounded by insulation 302. A lower container 308 with door 310 is also surrounded by insulation 302.

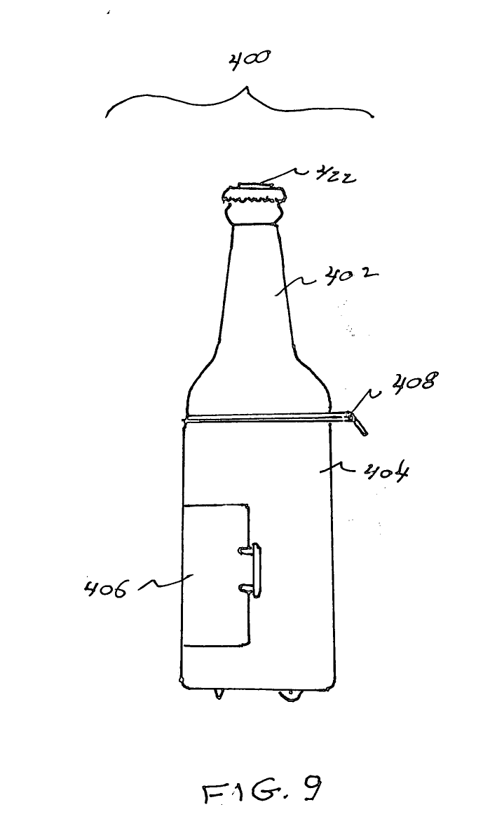

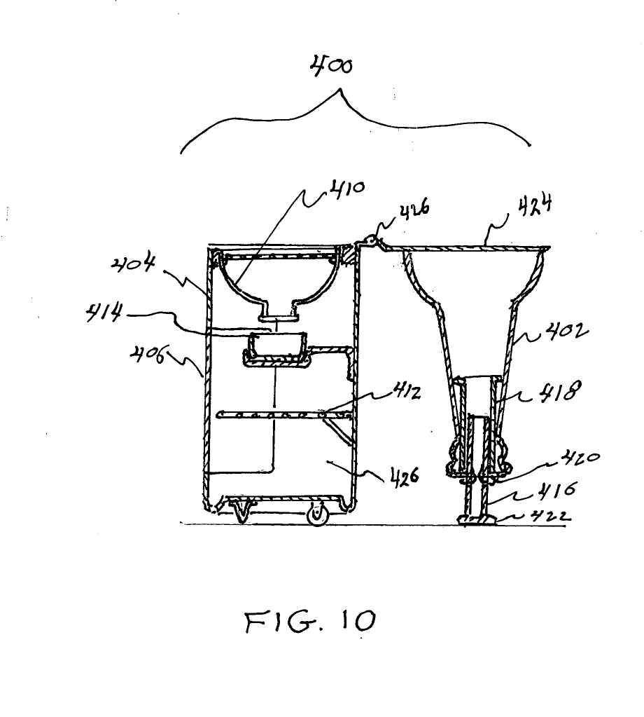

FIG. 9 shows a side view of a third alternate embodiment of the invention 400 which looks like a standard beer bottle rather than the beer can design shown in the original embodiment. The bottle is comprised of a top portion 402 and a bottom portion 404. The bottom portion is the same size and shape as the beer can design, so the same internal components can be used as described and illustrated above. FIG. 10 shows a side section view of the beer bottle version 400 in the open position. The top portion 402 is connected to the bottom portion 406 by hinge member 426. Flat portion 424 can be used as a table top work surface. Support post 416 terminates in bottom foot 422 and supports the beer bottle top portion 402 when in the use position as shown. The support post 416 is slidably retained by tubular member 418 and locked in place by spring pins 420. The embodiment shown is a charcoal version and contains main charcoal bowl 410 as well as ash catcher 414. Door 406 operates in the same manner as in the original embodiment. A shelf member 412 helps make maximum use of the lower storage area 426.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. beverage can shaped grill comprising:
a hollow cylindrical member that is proportional and similar in shape to the sides of a standard twelve ounce metal beverage can;
a fixedly attached plate forming a bottom portion for said cylindrical shape;
a hinged top member forming a first grill cover that is proportional and similar in shape to the top of a standard twelve ounce beverage can;
a hinged support member that when folded is flush with the outside surface of said cylindrical shape and when opened can support said hinged top member in a position that is parallel to the ground;
a hinged door member that when closed is flush with the outside surface of said cylindrical shape;
a standard gas grill burner plenum;
a standard gas grill base enclosure having a circular base plate and attached side walls;
a standard gas grill flame controlling device;
a standard gas grill tank hookup;
a standard gas grill cooking surface;
a second grill cover;
said standard gas grill base residing at the upper region within said hollow cylindrical member and sized to allow free air space between the outer walls of said grill enclosure and the inner walls of said cylindrical member;
said standard grill cooking surface residing within said grill base enclosure in a standard way;
a plurality of heat resisting support members;
said heat resisting support members attached on one side to the outer side wall of said standard grill base enclosure and on the opposite side to the inside wall of said hollow cylindrical member;
said hollow cylindrical member capable of removably retaining a standard gas tank;
said gas grill hookup residing within said cylindrical member in a standard way;
said standard grill flame controlling device available for use when said hinged door member is opened; and
said hinged door member large enough to allow a user to remove and replace said standard gas tank.
said second grill cover removably residing within said cylindrical member;
said second grill cover capable of covering said grill enclosure member during a grilling event.

2. Beverage can shaped grill as claimed in claim 1 wherein said hinged door includes a plurality of hooks fixedly attached to the inside surface for removably retaining standard grilling tools.

3. Beverage can shaped grill as claimed in claim 1 wherein the outside surface of said cylindrical member is printed with a proportionally sized of a graphic design found on a standard beverage can.

4. Beverage can shaped grill as claimed in claim 1 further comprising a pair of wheels attached by a standard shaft means to said can bottom portion.

5. Beverage can shaped grill as claimed in claim 1 further comprising a hinged pull handle that when in the closed position is flush with the outside wall of said cylindrical member.

6. A first alternate embodiment of the beverage can shaped grill as claimed in claim 1 wherein the heat producing portion of the grill is a standard charcoal burning assembly.

7. A second alternate embodiment of the beverage can shaped grill as claimed in claim 1 wherein insulated containers take the place of said grill assembly thereby making the invention into a food storage cooler.

8. A third alternate embodiment of the beverage can shaped grill as claimed in claim 1 wherein a standard beer bottle outer shape is employed instead of said beer can shape.
